(19) United States
(12) Patent Application Publication
(10) Pub. No.: US 2004/0165842 A1
(43) Pub. Date: Aug. 26, 2004

(54) Flexible pressure tube for conduction of a pressure medium and data transmission between pneumatically-operated structures

(75) Inventors: Herbert Krebs, Garbsen (DE); Wolfgang Brandes, Hannover (DE); Norbert Fortmann, Hannover (DE); Ernst-August Meyer, Wennigsen (DE); Thomas Liesenhoff, Hannover (DE)

Correspondence Address: HENRY M FEIEREISEN, LLC, 350 FIFTH AVENUE, SUITE 4714, NEW YORK, NY, 10118, US

(73) Assignee: REXROTH MECMAN GMBH, Hannover (DE)

(21) Appl. No.: 10/785,800

(22) Filed: Feb. 24, 2004

(30) Foreign Application Priority Data
Feb. 24, 2003 (DE) 103 07 985.8-24

(51) Int. Cl. G02B 6/44

(52) U.S. Cl. 385/100

(57) ABSTRACT

A flexible pressure tube includes a pressure tube cladding defining an axis and having an interior space for flow of a pressurized medium. The pressure tube cladding is constructed in the form of a homogeneous layer which is suitable to transmit data encoded in light waves in a direction of the axis, wherein the homogeneous layer is made of a flexible optical waveguide material. The pressure tube may be part of an apparatus for conducting pressurized medium and transmission of data, which apparatus includes a coupling assembly having a coupling unit for connecting one axial end of the flexible pressure tube to a pressurized-medium-operated structure, and another coupling unit for connecting the other axial end of the flexible pressure tube to a pressurized-medium-operated structure. Each of the coupling units is constructed to include a connection for the pressurized medium and an integrated communication device.

### CROSS-REFERENCES TO RELATED APPLICATIONS

This application claims the priority of German Patent Application, Serial No. 103 07 985.8-24, filed Feb. 24, 2003, pursuant to 35 U.S.C. 119(a)-(d), the disclosure of which is incorporated herein by reference.

### BACKGROUND OF THE INVENTION

The present invention relates, in general, to a flexible pressure tube for conducting a pressure medium, and to an apparatus which includes a pressure tube of this type.

Flexible pressure tubes of this type are primarily used in automation technology, more particularly in fluid technology, whenever the transmission of pressure media, such as for controlling machines via valves, cylinders and/or switches, is needed. Besides the energy transmitted by means of the pressure medium in the form of a pressure, data are additionally needed or transmitted for controlling (with or without feedback), switching, monitoring etc. Various types of pressurized media may be distinguished. In the field of application involved here, primarily pneumatic pressure media, such as pressurized air, are transmitted. The pressurized air is mainly transmitted through flexible pressure tubes enabling local, flexible energy transmission even to complex, or hard-to-access, pneumatically-operated structures. The data are usually transmitted in the form of electric signals via additional connections, cables, wires, and the like, capable of conducting electric current. To date, the transmission of pressure media and data is not possible within a common medium, because too many malfunctions occur and the transmission proved unreliable and erratic. For this reason, separate lines or transmission channels are needed for data transmission and pressure transmission.

German utility model no. DE 297 09 748 U1 describes a flexible pressure tube having an energy conductor for transmitting control and feeding energy and signals. The energy conductor is formed as a hybrid conductor and includes at least one pressure-tight fluid conductor, at least one electric conductor and/or at least one optical waveguide, and at least one tube forming a fluid and pressure-tight conductor and integrally surrounding the other conductors. This type of pressure tube suffers shortcomings because of the need for numerous components to construct the energy conductor and the complexity of the single-piece manufacture of the tube for tightly embracing all components. In particular, the complex cross-sections and the integration of a conductor in the tube render the manufacture of such energy conductors very complicated. Due to the complex cross-sectional geometry, connecting or coupling the conventional pressure tube to adjoining components is very cumbersome. There is clearly a need for a simple and reliable connection unit for coupling the energy conductor to further components.

It would therefore be desirable and advantageous to provide an improved flexible pressure tube which obviates prior art shortcomings and which is simple in structure while yet reliable in operation, and is easy to make.

### SUMMARY OF THE INVENTION

According to one aspect of the present invention, a flexible pressure tube includes a pressure tube cladding defining an axis and having an interior space for flow of a pressurized medium, wherein the pressure tube cladding is constructed in the form of a homogeneous layer which is suitable to transmit data encoded in light waves in a direction of the axis, wherein the homogeneous layer is made of a flexible optical waveguide material.

The present invention resolves prior art problems by forming the pressure tube cladding as a homogeneous layer, so that the pressure tube cladding is simple to manufacture and eliminates the need to provide separate means to embrace data or signal lines included or otherwise integrated in the pressure tube cladding. Since the pressure tube cladding is made of a flexible optical waveguide material, the need for additional components, such as, e.g., separate optical waveguides or other data conductors additionally integrated in the cladding, is eliminated. As a result, manufacturing costs are reduced to a minimum. The use of complex cross-sections in order to integrally manufacture the pressure tube is eliminated, since complex cross-sections with webs and/or protrusions that optionally contain additional data conductors can be omitted, and instead simple cross-sections, such as circular cross-sections, may be used.

According to another feature of the present invention, the pressurized medium may be pressurized air for operating a pneumatically-operated structure or a plurality of pneumatically-operated structures. Of course, the use of other pressure media or fluids, such as hydraulic fluids, is conceivable as well. It is to be understood by persons skilled in the art that the term “pneumatically-operated structure” is used here in a generic sense and includes any parts or components usable in pneumatics, that are operated by a pressurized medium such as pressurized air. Examples of pneumatically-operated structures include valves, cylinders and/or switches.

According to another feature of the present invention, the pressure tube cladding may have an outer surface layer and an inner surface layer, with the data encoded in light waves essentially transmitted within the pressure tube cladding between the inner surface layer and the outer surface layer. In this way, the light waves are well shielded within the pressure tube cladding against external media surrounding the optical waveguide, so that data transmission may be reliably carried out without interference. This type of shielding thus ensures optimum data transmission at a very high transmission rate, resulting in minimum energy consumption in the transmission, since no energy-consuming sinks as a result of interfering effects exist, so that overall the data transmission is highly efficient.

Suitably, the inner surface layer of the pressure tube cladding is constructed to prevent a passage of pressurized medium through the inner surface layer into the homogeneous layer of the pressure tube cladding, thereby separating the data transmission from the flow of pressurized medium in the interior space. As the pressure medium conduction and the data transmission as well as the pressure medium and the data transmission medium interfere with one another, so that the use of a common transmission within a common medium, within a common conductor or a common layer is technically impossible and inefficient, and can be realized only in a very complex manner, it is advantageous to carry out the data transmission and the conduction of pressurized medium in different, separate and mutually shielded zones. Due to the mutually adverse effects, there should be a barrier, for example in the form of a surface or a boundary surface, or an outer surface and/or inner surface to prevent the pressure medium and the data from adversely affecting each other. Since the pressure medium is transmitted within the pressure tube or in the interior space of the pressure tube, and the data transmission is carried out in the pressure tube cladding, the inner surface forms this boundary layer or boundary surface. Through suitable design, a barrier separating the data transmission and the pressure medium transmission can be realized in a simple manner.

Similarly, the outer surface layer of the pressure tube cladding may be constructed to prevent penetration of an external medium, surrounding the pressure tube cladding, into the homogeneous layer of the pressure tube cladding, thereby separating the data transmission from the external medium. If the surrounding medium is the same medium as the pressure medium, the same is true for the outer surface layer as stated previously in conjunction with the inner surface layer. If, however, the surrounding medium varies from the pressure medium transmitted within the pressure tube, or if it is an entirely different medium, the outer barrier has to be formed in an appropriately different way. Through proper design of the outer barrier, the pressure tube may even be used under water or in other media, without adversely affecting its operability. In this way, a broad range of applications and fields of use is possible.

According to another feature of the present invention, the pressure tube cladding may be disposed in substantial concentric relationship to the pressure tube axis. In this way, the pressure tube is easier to manufacture as opposed to an eccentric disposition of the pressure tube cladding and the pressure tube axis. However, it is also conceivable that in some cases an eccentric arrangement is advantageous, for example, when additional protrusions are provided on the pressure tube. These are the exceptions, however, so that a concentric relationship of the pressure tube cladding and the pressure tube axis is currently preferred and effectively covers a wide variety of applications, which, combined with a simpler manufacture, makes it possible to have an optimum manufacturing method at low cost.

According to another feature of the present invention, the pressure tube cladding may have a substantially constant layer thickness over an entire length thereof in radial direction to the pressure tube axis in order to ensure uniform data and/or pressure medium flow. Of course, any other layer thickness or wall thickness may also be possible. The wall thickness could, for example, be continuously reduced or increased. Any variable wall thickness is also possible depending on the field of use. In areas that require high flexibility, the wall thickness could, for example, be reduced in order for the pressure tube to be more easily deformable and therefore more easily adaptable to ambient conditions. On the other hand, regions of the pressure tube that are exposed to great stress, whether caused by external or internal influences, may require a greater wall thickness or layer thickness to achieve higher stability, strength or rigidity. For easy manufacture of a flexible pressure tube, it is, however, advantageous for the wall thickness to be constant over the entire length of the tube, so as to eliminate the need for manufacturing methods involving complicated programming, in particular when manufacture on an industrial scale is involved. As a consequence, less costly manufacturing machines can be used.

According to another feature of the present invention, the interior space may have a cylindrical configuration, i.e. a circular cross-sectional area, to ensure a constant flow of pressurized medium. The provision of a circular cross-section and a constant wall thickness or layer thickness results necessarily in a hollow cylindrical or hollow circular cross-section of the tube cladding. Of course, both the pressure tube interior space and the pressure tube cladding may exhibit any desired cross-section. Also, the pressure tube cladding and the pressure tube interior space need not necessarily have corresponding cross-sections, i.e. cylindrical and hollow cylindrical or square and hollow square cross-sections. It is also conceivable, for example, for the pressure tube interior space to have a circular cross-section and the pressure tube cladding to have a square cross-section. It is also conceivable for the cross-section to be variable along the pressure tube axis. The cross-sectional area of the pressure tube interior space may, for example, taper in a flow direction of the pressure medium. The cross-section of the pressure tube cladding can be formed independently of the cross-section of the pressure tube interior space. However, with respect to the flow rate of the pressure medium within the pressure tube and in terms of efficiency for the pressure tube, the provision of a circular cross-section across the pressure tube axis is currently preferred. Moreover, this cross-section involves the lowest manufacturing cost and, compared with other geometrical shapes, and provides the greatest surface area (or volume) to circumference (or cladding area) ratio, so that this form of the cross-sectional area requires the lowest structural volume in comparison to other geometrical shapes at equal flow rates.

According to another aspect pf the present invention, an apparatus for conducting a pressurized medium and transmission of data, includes a flexible pressure tube having a pressure tube cladding which defines an axis and has an interior space for flow of a pressurized medium, wherein the pressure tube cladding has opposite axial ends and is constructed in the form of a homogeneous layer which is suitable to transmit data encoded in light waves in a direction of the axis and is made of a flexible optical waveguide material, and a coupling assembly having a coupling unit for connecting one axial end of the flexible pressure tube to a pressurized-medium-operated structure, and another coupling unit for connecting the other axial end of the flexible pressure tube to a pressurized-medium-operated structure, each said coupling unit constructed to include a medium connection for the pressurized medium and an integrated communication device.

In this way, the flexible pressure tube according to the invention can be connected in a simple way to further pneumatically-operated structures or pneumatic components via the coupling assembly. Again, it is to be understood by persons skilled in the art that the term “pneumatically-operated structure” is used here in a generic sense and includes any parts or components usable in pneumatics, that are operated by a pressurized medium such as pressurized air. Examples of pneumatically-operated structures include valves, cylinders and/or switches, even entire large-scale plants. Each coupling unit may have the shape of a rectangular parallelepiped or block in order to ensure a simple modular structure. As a consequence of the modular design of the coupling assembly, an apparatus according to the present invention is easy to assemble and can be connected to any standardized structure. The coupling unit may be either an independent part, or a component integral with a pneumatic part. The modular configuration allows also the arrangement of a plurality of such apparatuses for material and data transmission in sequential or side-by-side relationship, or combination of sequential or side-by-side dispositions to form complex assembly to allow a material and data transmission over great distances.

According to another feature of the present invention, the communication device of the coupling unit may include at least one optical transmitter and at least one optical receiver to realize a bi-directional data communication between the coupling units. In this way, an actual value may be detected by means of a sensor, preferably an optical sensor, and optically transmitted by means of a transmitter, preferably an optical transmitter, to a receiver. This means that the present invention is not limited to encoding the data in optical units, but the data may be detected and forwarded using any coding method. If necessary, the encoded data may have to be suitably converted by means of converters. A fastest transmission is however, implemented by means of optically encoded signals. A setpoint-to-actual comparison may be made by means of the signal received by the receiver. The result of this comparison can be rapidly forwarded or returned by means of an optical transmitter, for example to a control element for addressing a manipulated variable. By means of the bi-directional data communication, a feedback control or control loop may thus easily be realized, for example, to be integrated into a superordinated control system.

In order to provide a data transmission that is as fast and reliable as possible, it is advantageous for the transmitter to be constructed as an infrared transmitter and the receiver to be constructed as an infrared receiver, so that data may be encoded and transmitted by means of infrared waves. Since light propagates at the highest possible speed, a fastest possible data transmission is realized, using infrared waves.

According to another feature of the present invention, the transmitter and/or the receiver of the communication device may be constructed in the form of an infrared diode to transmit data encoded in infrared waves. The infrared diode may hereby be formed as an infrared wave emitter for generating infrared waves or as an infrared wave detector for recognizing, reading, detecting and receiving infrared waves. An infrared diode is a commercially available standard component for the generation and detection of infrared light waves, which is simple to assemble and which, due to its small structural size, requires little structural space within a system comprising the infrared diode.

According to another feature of the present invention, the medium connection of each of the coupling units may be constructed in the form of a push-in fitting or as an interface to transmit pressurized air as pressurized medium between pneumatically-operated structures. The medium connection may generally be formed in various ways depending on the pressurized medium or material to be transmitted. It should be understood, however, that medium connection and the medium to be transmitted have to be formed accordingly. By adapting the medium connection as an air coupling or a pressurized air coupling, a pressurized air connection may be realized in a simple manner and at low cost.

According to another feature of the present invention, the communication device may include a communication interface for contacting the pressure tube cladding and the communication device, wherein the communication interface is constructed to provide a substantially wear-resistant contact between the pressure tube cladding and the communication device. The interface may be integrated in the communication device or may be an independent, exchangeable module of the communication device. The interface enables a connection between the pressure tube, i.e. the pressure tube cladding, and the communication device in a simple and low-cost manner, since in particular when a modular interface is used, a standardized interface covering a wide range of applications may be used. If the interface becomes defective or damaged, or if wear and tear or malfunction is encountered, the interface may easily be detached from the communication device and replaced. By using a communication interface of the above type, a very high degree of flexibility and compatibility is achieved.

According to another feature of the present invention, the communication interface may be disposed in substantially surrounding relationship to the pressure tube cladding so as to realize a force-locking engagement of the axial ends of the flexible pressure tube with the coupling units. Thus the pressure tube end can be optimally protected against external influences, such as by media surrounding the tube end, without adversely affecting its function. The force-locking engagement also ensures a safe and reliable connection while having a long service life.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic longitudinal sectional view of a flexible pressure tube according to the present invention;

FIG. 2 is a schematic cross-sectional view of the flexible pressure tube of FIG. 1; and

FIG. 3 is a schematic longitudinal sectional view of an apparatus for material and data transmission in accordance with the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

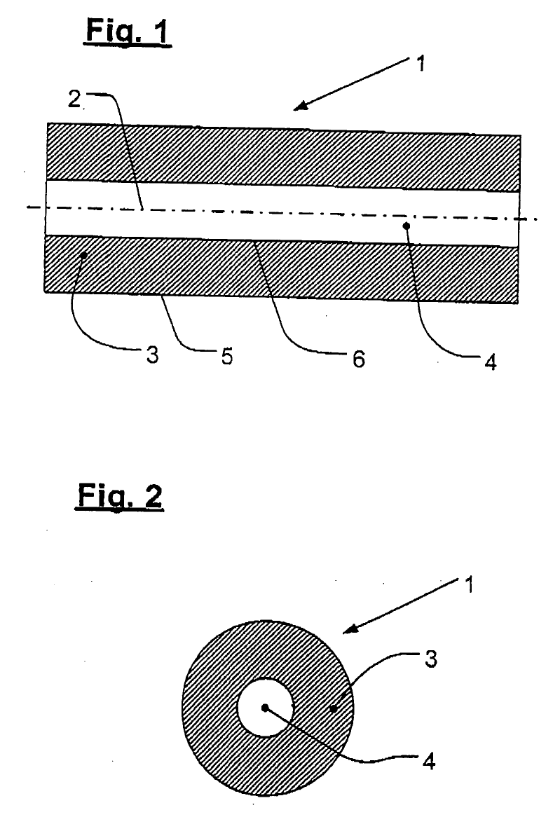

Turning now to the drawing, and in particular to FIG. 1, there is shown a schematic longitudinal sectional view of a flexible pressure tube according to the present invention, generally designated by reference numeral 1. The flexible pressure tube 1 defines a pressure tube axis 2 and includes a pressure tube cladding 3 extending about the axis 2 and bounding a pressure tube interior space 4. The pressure tube 1 has two surfaces in a radial direction to pressure tube axis 2. One of these surfaces is formed by an outer surface layer 5 which provides a barrier against a medium surrounding the pressure tube 1. The other of these surfaces is formed by an inner surface layer 6 which provides a barrier to separate the pressure tube cladding 3 from the interior space 4. The layers 5, and 6 consists from reflective metal or non-transparent plastics material. The pressure tube cladding 3 is made of a flexible, i.e. deformable, optical waveguide material, such as polyamide or polyurethane, so that light waves may be transmitted within the pressure tube cladding 3. The pressure tube cladding 3 has a constant wall thickness in an axial direction of the pressure tube axis 2.

Referring now to FIG. 2, which shows a cross-sectional view of the pressure tube 1, it can be seen that the interior space 4 has a cylindrical configuration, i.e. a circular cross-section. The pressure tube cladding 3 is arranged in concentric relationship to the interior space 4 and has a hollow cylindrical shape, i.e. a hollow circular cross-section.

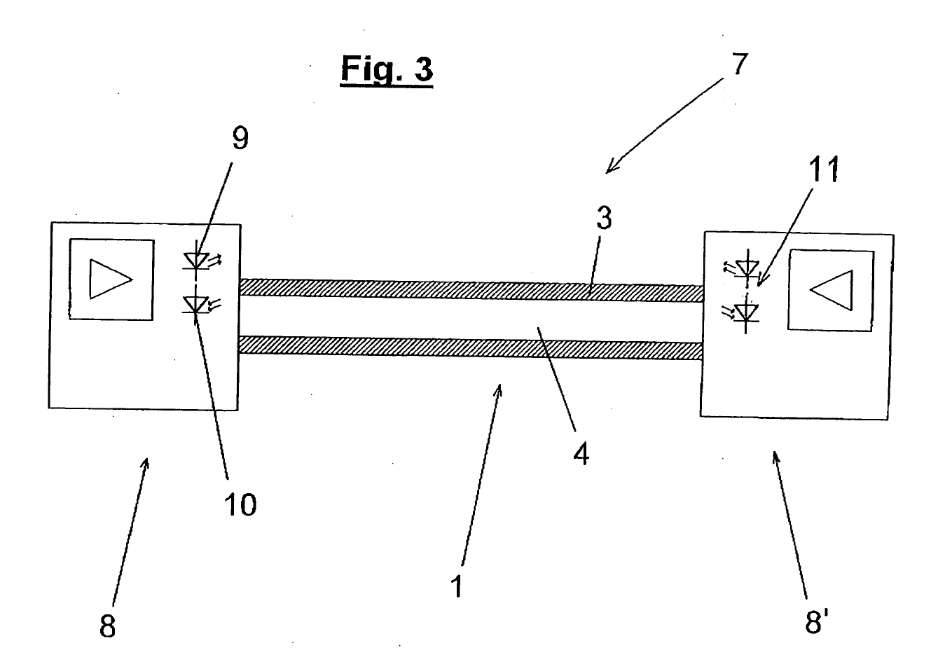

Turning now to FIG. 3, there is shown a schematic longitudinal sectional view of an apparatus for material and data transmission in accordance with the present invention, generally designated by reference numeral 7. The apparatus 7 for material and data transmission includes a flexible pressure tube 1, as shown in FIGS. 1 and 2, and a coupling assembly comprised of two coupling units 8, 8′ positioned respectively at the axial ends of the flexible pressure tube 1 and connected thereto. The axial ends of the pressure tube 1 are in frictional or force-locking engagement with the coupling units 8, 8′ by means of a first interface (not shown). Each of the coupling units 8, 8′ is preferably shaped in the form of a rectangular parallelepiped. The first interface is provided on the pressure-tube-facing side of the coupling units 8, 8′ and embraces the axial ends of the pressure tube 1 to interact with the pressure tube 1 in such a way that a reliable force-locking engagement is realized. A pressurized medium is thus fed, via the first interface between the coupling unit 8 and the pressure tube 1 into the interior space 4 and conducted to the opposite first interface between the pressure tube 1 and the coupling unit 8′ on the other axial end of flexible pressure tube 1. Apart from the first interface, the coupling assembly may also have a second interface (not shown) for connecting the coupling units 8, 8′ to further pneumatically-operated structures. The two interfaces together ensure transmission of data and pressurized medium between the pressure tube 1 via the coupling units 8, 8′ to the pneumatically-operated structures to be coupled thereto.

Each of the coupling units 8, 8′ includes a communication device 11 which comprises a transmitter 9 and a receiver 10. The transmitter 9 is implemented as an optical transmitter, e.g., an infrared wave transmitter with an infrared diode. The infrared diode of the transmitter 9 is configured as an infrared emitter radiating infrared waves to transmit information in the form of infrared light waves. The receiver 10 is implemented as an optical receiver, e.g., an infrared light wave receiver, and also includes an infrared diode. Unlike the infrared diode of the transmitter 9, the infrared diode of the receiver 10 is an infrared detector for receiving infrared waves from a corresponding infrared transmitter. The infrared waves are transmitted from one of the coupling units 8, 8′ to the other one of the coupling units 8, 8′ at the axial ends of the pressure tube 1 via the pressure tube cladding 3. The two coupling units 8 are designed to realize a bi-directional communication between the two coupling units 8 via the pressure tube cladding 3.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A flexible pressure tube, comprising a pressure tube cladding defining an axis and having an interior space for flow of a pressurized medium, said pressure tube cladding being constructed in the form of a homogeneous layer which is suitable to transmit data encoded in light waves in a direction of the axis, wherein the homogeneous layer is made of a flexible optical waveguide material.

2. The pressure tube of claim 1, wherein the pressurized medium is pressurized air for operating a pneumatically-operated structure.

3. The pressure tube of claim 1, wherein the pressure tube cladding has an outer surface layer and an inner surface layer, with the data encoded in light waves substantially propagating within the pressure tube cladding between the inner surface layer and the outer surface layer.

4. The pressure tube of claim 3, wherein the inner surface layer of the pressure tube cladding is constructed as barrier to prevent a passage of pressurized medium through the inner surface layer into the homogeneous layer of the pressure tube cladding, thereby separating the data transmission from the flow of pressurized medium in the interior space.

5. The pressure tube of claim 3, wherein the outer surface layer of the pressure tube cladding is constructed as barrier to prevent penetration of external medium, surrounding the pressure tube cladding, into the homogeneous layer of the pressure tube cladding, thereby separating the data transmission from the external medium.

6. The pressure tube of claim 1, wherein the pressure tube cladding is disposed in substantial concentric relationship to the axis.

7. The pressure tube of claim 1, wherein the pressure tube cladding has a substantially constant layer thickness over an entire length thereof in radial direction to the axis.

8. The pressure tube of claim 1, wherein the interior space has a cylindrical configuration to ensure a constant flow of pressurized medium.

9. An apparatus for conducting a pressurized medium and transmission of data, comprising:
a flexible pressure tube including a pressure tube cladding which defines an axis and has an interior space for flow of a pressurized medium, said pressure tube cladding having opposite axial ends and constructed in the form of a homogeneous layer which is suitable to transmit data encoded in light waves in a direction of the axis, wherein the homogeneous layer is made of a flexible optical waveguide material; and
a coupling assembly having a coupling unit for connecting one axial end of the flexible pressure tube to a pressurized-medium-operated structure, and another coupling unit for connecting the other axial end of the flexible pressure tube to a pressurized-medium-operated structure, each said coupling unit constructed to include a medium connection for the pressurized medium and an integrated communication device.

10. The apparatus of claim 9, wherein the communication device of the coupling unit includes at least one optical transmitter and at least one optical receiver to realize a bi-directional data communication between the coupling units.

11. The apparatus of claim 10, wherein the transmitter is constructed in the form of an infrared transmitter, and the receiver is constructed in the form of an infrared receiver, for transmission of data encoded by infrared waves.

12. The apparatus of claim 10, wherein at least one of the transmitter and the receiver of the communication device is constructed in the form of an infrared diode to transmit data encoded in infrared waves.

13. The apparatus of claim 9, wherein the connection of each of the coupling units is constructed in the form of a push-in fitting to transmit pressurized air as pressurized medium between pneumatically-operated structures.

14. The apparatus of claim 9, wherein the communication device includes a communication interface for contacting the pressure tube cladding and the communication device, said communication interface constructed to provide a substantially wear-resistant contact between the pressure tube cladding and the communication device.

15. The apparatus of claim 14, wherein the communication interface is disposed in substantially surrounding relationship to the pressure tube cladding so as to realize a force-locking engagement of the axial ends of the flexible pressure tube with the coupling units.

16. The apparatus of claim 14, wherein the each coupling unit is configured in the shape of a rectangular parallelepiped to ensure a simple modular structure.

17. The apparatus of claim 12, wherein the infrared diode is constructed as an infrared wave emitter for generating infrared waves.

18. The apparatus of claim 12, wherein the infrared diode is constructed as an infrared wave detector for recognizing, reading, detecting and receiving infrared waves.
